(19) United States
(12) Patent Application Publication
(10) Pub. No.: US 2019/0163646 A1
(43) Pub. Date: May 30, 2019

(54) CYCLIC PRELOADING MECHANISM TO DEFINE SWAP-OUT ORDERING FOR ROUND ROBIN CACHE MEMORY

(71) Applicant: INTERNATIONAL BUSINESS MACHINES CORPORATION, Armonk, NY (US)

(72) Inventor: Jun Doi, Kanagawa-ken (JP)

(21) Appl. No.: 15/825,890

(22) Filed: Nov. 29, 2017

(51) Int. Cl. G06F 12/123; G06F 12/128; G06F 5/06; G06F 13/37

(52) U.S. Cl. CPC G06F 12/123; G06F 12/128; G06F 2212/621; G06F 13/37; G06F 2205/067; G06F 5/065

(57) ABSTRACT

A computer-implemented method is provided for managing a cache operatively coupled to at least one processor. Round robin swap-out ordering is used for the cache. The method includes dividing a set of data regions accessed by a calculation into data blocks. A size of the data blocks is less than a size of the data regions. The method further includes cyclically queuing the data blocks from the data regions into a FIFO before an actual use of the data regions by the calculation. The method also includes cyclically preloading the data blocks of a data region to be processed from the FIFO into the cache before the actual use of the data regions by the calculation.

### BACKGROUND

### Technical Field

The present invention relates generally to memories and, in particular, to a cyclic preloading mechanism to define a swap-out ordering for a round robin cache memory.

### Description of the Related Art

Round robin swap-out ordering is widely used for cache memory or unified memory (GPU), because of low overhead and ease of implementation. However, the cache hit ratio for round robin swap-out is lower than Least Recently Used (LRU) ordering. For some sequence of repeated memory access patterns, e.g., deep learning, data that is likely to be reused of swapped-out. Hence, there is a need for a mechanism to define swap-out ordering for a round robin cache memory.

### SUMMARY

According to an aspect of the present invention, a computer-implemented method is provided for managing a cache operatively coupled to at least one processor. Round robin swap-out ordering is used for the cache. The method includes dividing a set of data regions accessed by a calculation into data blocks. A size of the data blocks is less than a size of the data regions. The method further includes cyclically queuing the data blocks from the data regions into a FIFO before an actual use of the data regions by the calculation. The method also includes cyclically preloading the data blocks of a data region to be processed from the FIFO into the cache before the actual use of the data regions by the calculation.

According to another aspect of the present invention, a computer program product is provided for managing a cache operatively coupled to at least one processor. Round robin swap-out ordering is used for the cache. The computer program product includes a non-transitory computer readable storage medium having program instructions embodied therewith. The program instructions are executable by a computer to cause the computer to perform a method. The method includes dividing a set of data regions accessed by a calculation into data blocks. A size of the data blocks is less than a size of the data regions. The method further includes cyclically queuing the data blocks from the data regions into a FIFO before an actual use of the data regions by the calculation. The method also includes cyclically preloading the data blocks of a data region to be processed from the FIFO into the cache before the actual use of the data regions by the calculation.

These and other features and advantages will become apparent from the following detailed description of illustrative embodiments thereof, which is to be read in connection with the accompanying drawings.

### BRIEF DESCRIPTION OF THE DRAWINGS

The following description will provide details of preferred embodiments with reference to the following figures wherein:

FIG. 1 shows an exemplary processing system to which the present invention may be applied, in accordance with an embodiment of the present invention;

FIG. 2 shows an exemplary memory access pattern of deep learning to which the present invention can be applied, in accordance with an embodiment of the present invention;

FIG. 3 shows an exemplary method for cyclic preloading to define a swap-out ordering for a round robin cache memory, in accordance with an embodiment of the present invention; and

FIG. 4 shows an exemplary set of data regions to which the method of FIG. 3 can be applied, in accordance with an embodiment of the present invention.

### DETAILED DESCRIPTION

The present invention is directed to a cyclic preloading mechanism to define swap-out ordering for a round robin cache memory.

In an embodiment, round robin ordering is defined for each cache line or memory page (e.g., 64 Kb page for a unified memory implementation), not a whole data region. Cyclic preloading divides a sequence of divided regions into small pieces (a cache line or page size). Then, each piece of the regions is accessed cyclically in the sequence of access pattern before running the actual procedure. The round robin ordering is averaged in sequence of regions that prevent from swapping-out a whole data region, and cache hit ratio will be improved.

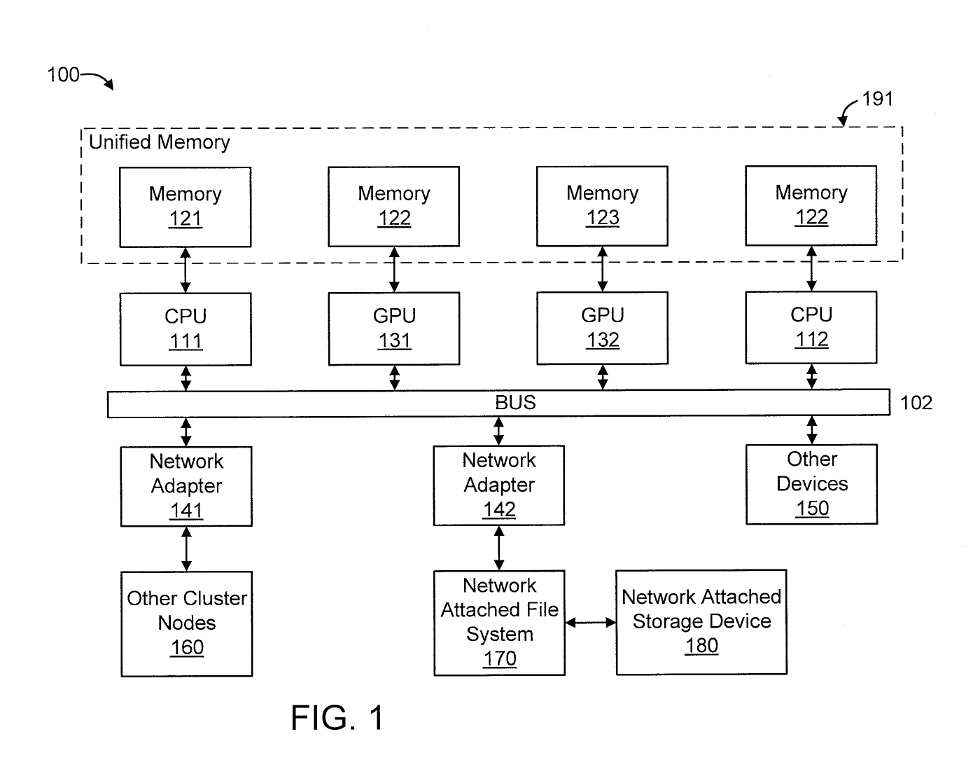

FIG. 1 shows an exemplary processing system 100 to which the invention principles may be applied, in accordance with an embodiment of the present invention. The processing system 100 includes multiple central processing units (CPUs) 111 and 112 and multiple Graphics Processing Units (GPUs) 121 and 122, each operatively coupled to other components via a system bus 102. Moreover, each of the processor units 111, 121, 122, and 112 is operatively coupled to a memory 121, 122, 123, and 124, respectively.

Network adapters 141 and 142, as well as other devices 150, are operatively coupled to the system bus 102. Other cluster nodes 160 are operatively coupled to network adapter 141. A network attached file system 170 is operatively coupled to the network adapter 142. A network attached storage device 180 is operatively coupled to the network attached file system 170.

In an embodiment, the memories 121, 122, 123, and 124 can form a unified memory implementation 191 wherein address space can be shared between these entities.

Of course, the processing system 100 may also include other elements (not shown), as readily contemplated by one of skill in the art, as well as omit certain elements. For example, various input devices and/or output devices can be included in processing system 100, depending upon the particular implementation of the same, as readily understood by one of ordinary skill in the art. For example, various types of wireless and/or wired input and/or output devices can be used. Moreover, additional processors, controllers, memories, and so forth, in various configurations can also be utilized as readily appreciated by one of ordinary skill in the art. These and other variations of the processing system 100 are readily contemplated by one of ordinary skill in the art given the teachings of the present invention provided herein.

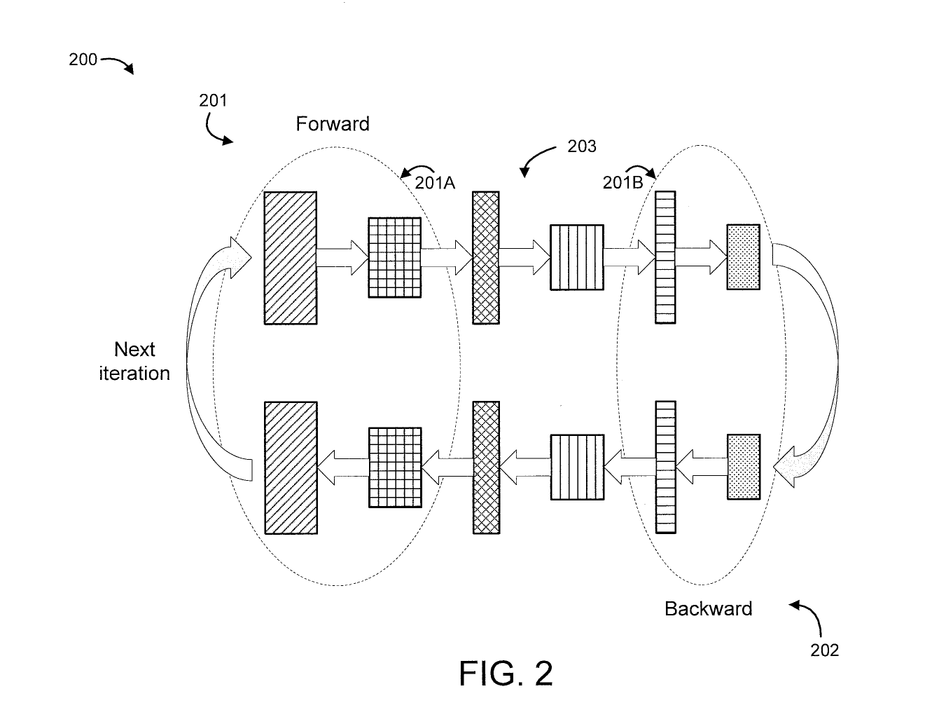

FIG. 2 shows an exemplary memory access pattern 200 of deep learning to which the present invention can be applied, in accordance with an embodiment of the present invention.

The memory access pattern 200 includes a forward propagation 201 and a backward propagation 202. The forward propagation includes and/or otherwise involves a data set 201A. The backward propagation includes and/or otherwise involves a data set 202A.

The memory access pattern 200 also includes data set 203. The data sets 201A and 202A, shown encircled by dashed lines, are likely to be reused on a cache during the deep learning. However, data likely to be reused is swapped-out. This problem is solved by embodiments of the present invention, as described herein below.

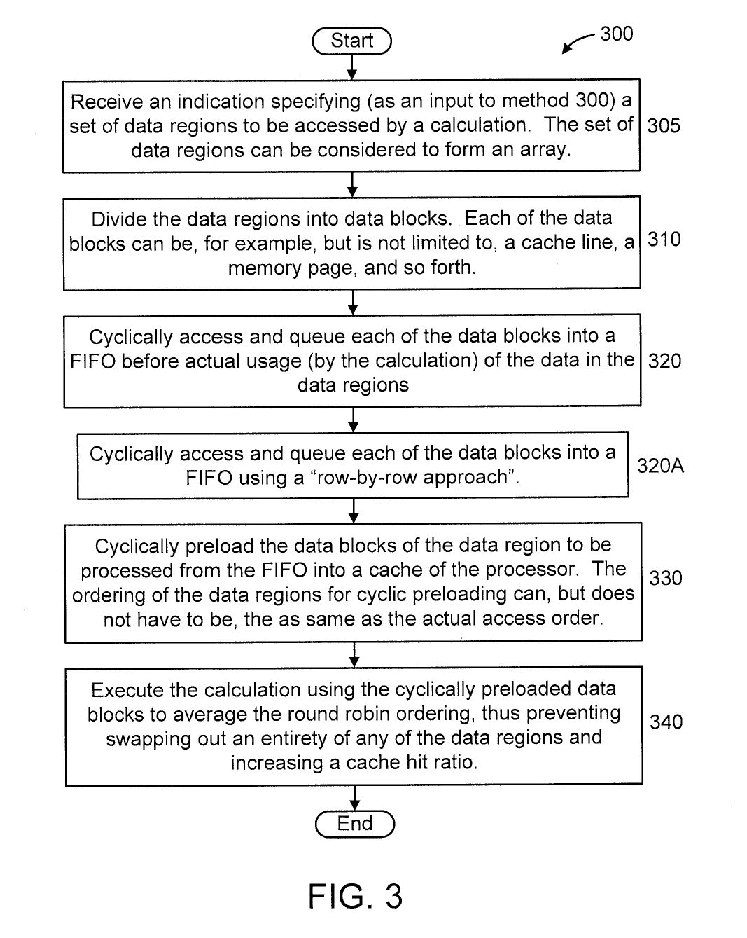

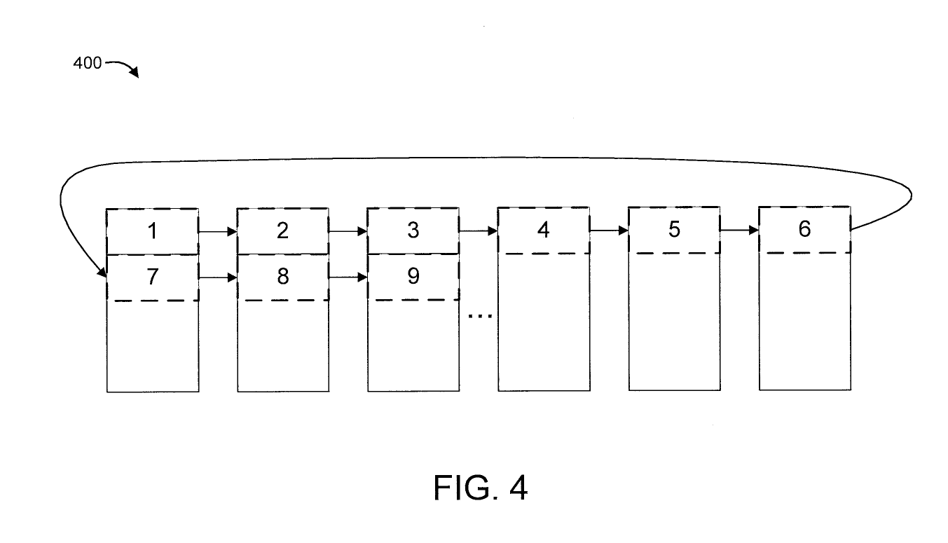

An example of the present invention will now be collectively described with respect to FIGS. 3 and 4. In particular, FIG. 3 shows an exemplary method 300 for cyclic preloading to define a swap-out ordering for a round robin cache memory, in accordance with an embodiment of the present invention. FIG. 4 shows an exemplary set of data regions 400 to which the method 300 of FIG. 3 can be applied, in accordance with an embodiment of the present invention. In FIG. 4, six data regions are shown using solid lines, while data blocks, which are essentially pieces of the data regions, are shown using dashed lines (and are numbered from 1 through 9).

It is to be appreciated that method 300 is essentially a method for managing a cache attached to a processor wherein round robin swap-out ordering is defined for each data block (e.g., cache line, memory page, etc.) to be processed, in accordance with an embodiment of the present invention.

Hence, method 300 involves the following precondition: Round robin ordering is defined for each cache line or memory page (64 KB page for GPU's Unified Memory implementation), not the whole data region. In this way, whole page swapping is advantageously prevented and the cache hit ratio is advantageously improved.

At step 305, receive an indication specifying (as an input to method 300) a set of data regions to be accessed by a calculation. The set of data regions can be considered to form an array.

At step 310, divide the data regions into data blocks. Each of the data blocks can be, for example, but is not limited to, a cache line, a memory page, and so forth. The point of step 310 is to divide the data regions into smaller pieces.

At step 320, cyclically access and queue each of the data blocks into a FIFO before actual usage (by the calculation) of the data in the data regions.

In an embodiment, step 320 includes step 320A.

At step 320A, cyclically access and queue each of the data blocks into a FIFO using a “row-by-row approach”. The “row-by-row approach” involves cyclically accessing and queuing each data block in a row before proceeding to the data blocks in a subsequent row, until the data blocks in all of the rows have been accessed and queued, as essentially shown by the arrows in FIG. 4.

At step 330, cyclically preload the data blocks of the data region to be processed from the FIFO into a cache of the processor. The ordering of the data regions for cyclic preloading can, but does not have to be, the as same as the actual access order.

At step 340, execute the calculation using the cyclically preloaded data blocks to average the round robin ordering, thus preventing swapping out an entirety of any of the data regions and increasing a cache hit ratio.

Hence, by allocating data regions by special function, the set of data regions can be collected and, before the actual calculation, cyclic pre-loading can be performed. Accordingly, the round robin ordering is averaged across a sequence of regions such that swapping-out a whole data region is prevents, and the cache hit ratio is improved.

It is to be appreciated that the cache can be associated with a CPU(s) (e.g., CPU 104), a GPU(s) (e.g., GPU 194), or a unified memory (e.g., unified memory 191) involving both a CPU(s) and a GPU(s). These and other variations of the present invention are readily determined by one of ordinary skill in the art, given the teachings of the present invention provided herein, while maintaining the spirit of the present invention.

The present invention may be a system, a method, and/or a computer program product at any possible technical detail level of integration. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as SMALLTALK, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

Reference in the specification to “one embodiment” or “an embodiment” of the present invention, as well as other variations thereof, means that a particular feature, structure, characteristic, and so forth described in connection with the embodiment is included in at least one embodiment of the present invention. Thus, the appearances of the phrase “in one embodiment” or “in an embodiment”, as well any other variations, appearing in various places throughout the specification are not necessarily all referring to the same embodiment.

It is to be appreciated that the use of any of the following “/”, “and/or”, and “at least one of”, for example, in the cases of “A/B”, “A and/or B” and “at least one of A and B”, is intended to encompass the selection of the first listed option (A) only, or the selection of the second listed option (B) only, or the selection of both options (A and B). As a further example, in the cases of “A, B, and/or C” and “at least one of A, B, and C”, such phrasing is intended to encompass the selection of the first listed option (A) only, or the selection of the second listed option (B) only, or the selection of the third listed option (C) only, or the selection of the first and the second listed options (A and B) only, or the selection of the first and third listed options (A and C) only, or the selection of the second and third listed options (B and C) only, or the selection of all three options (A and B and C). This may be extended, as readily apparent by one of ordinary skill in this and related arts, for as many items listed.

Having described preferred embodiments of a system and method (which are intended to be illustrative and not limiting), it is noted that modifications and variations can be made by persons skilled in the art in light of the above teachings. It is therefore to be understood that changes may be made in the particular embodiments disclosed which are within the scope of the invention as outlined by the appended claims. Having thus described aspects of the invention, with the details and particularity required by the patent laws, what is claimed and desired protected by Letters Patent is set forth in the appended claims.

What is claimed is:

1. A computer-implemented method for managing a cache operatively coupled to at least one processor, wherein round robin swap-out ordering is used for the cache, the method comprising:
dividing a set of data regions accessed by a calculation into data blocks, wherein a size of the data blocks is less than a size of the data regions;
cyclically queuing the data blocks from the data regions into a FIFO before an actual use of the data regions by the calculation; and
cyclically preloading the data blocks of a data region to be processed from the FIFO into the cache before the actual use of the data regions by the calculation.

2. The computer-implemented method of claim 1, wherein an ordering of the data regions from which data blocks are used for the cyclically queueing step is equal to an ordering of the data regions from which the data blocks are used for the cycling preloading step.

3. The computer-implemented method of claim 1, wherein an ordering of the data regions from which data blocks are used for the cyclically queueing step is unequal to an ordering of the data regions from which the data blocks are used for the cycling preloading step.

4. The computer-implemented method of claim 1, wherein the method is performed by a computer processing system having a unified memory system, and wherein the at least one processor comprises a central processing unit and a graphics processing unit forming at least a portion of the unified memory system.

5. The computer-implemented method of claim 1, further comprising executing the calculation using the cyclically preloaded data blocks to average the round robin ordering across the data blocks.

6. The computer-implemented method of claim 1, further comprising preventing swapping out an entirety of any of the data regions, by executing the calculation using the cyclically preloaded data blocks to average the round robin ordering across the data blocks.

7. The computer-implemented method of claim 1, further comprising increasing a cache hit ratio, by executing the calculation using the cyclically preloaded data blocks to average the round robin ordering across the data blocks.

8. The computer-implemented method of claim 1, wherein said dividing step divides each of the data regions into a respective plurality of cache lines.

9. The computer-implemented method of claim 1, wherein said dividing step divides each of the data regions into a respective plurality of memory pages.

10. The computer-implemented method of claim 1, wherein the method is performed by the at least one processor.

11. A computer program product for managing a cache operatively coupled to at least one processor, wherein round robin swap-out ordering is used for the cache, the computer program product comprising a non-transitory computer readable storage medium having program instructions embodied therewith, the program instructions executable by a computer to cause the computer to perform a method comprising:
dividing a set of data regions accessed by a calculation into data blocks, wherein a size of the data blocks is less than a size of the data regions;
cyclically queuing the data blocks from the data regions into a FIFO before an actual use of the data regions by the calculation; and
cyclically preloading the data blocks of a data region to be processed from the FIFO into the cache before the actual use of the data regions by the calculation.

12. The computer program product of claim 11, wherein an ordering of the data regions from which data blocks are used for the cyclically queueing step is equal to an ordering of the data regions from which the data blocks are used for the cycling preloading step.

13. The computer program product of claim 11, wherein an ordering of the data regions from which data blocks are used for the cyclically queueing step is unequal to an ordering of the data regions from which the data blocks are used for the cycling preloading step.

14. The computer program product of claim 11, wherein the computer has a unified memory system, and wherein the at least one processor comprises a central processing unit and a graphics processing unit forming at least a portion of the unified memory system.

15. The computer program product of claim 11, wherein the method further comprises executing the calculation using the cyclically preloaded data blocks to average the round robin ordering across the data blocks.

16. The computer program product of claim 11, wherein the method further comprises preventing swapping out an entirety of any of the data regions, by executing the calculation using the cyclically preloaded data blocks to average the round robin ordering across the data blocks.

17. The computer program product of claim 11, wherein the method further comprises increasing a cache hit ratio, by executing the calculation using the cyclically preloaded data blocks to average the round robin ordering across the data blocks.

18. The computer program product of claim 11, wherein said dividing step divides each of the data regions into a respective plurality of cache lines.

19. The computer program product of claim 11, wherein said dividing step divides each of the data regions into a respective plurality of memory pages.

20. The computer program product of claim 11, wherein the method is performed by the at least one processor.
